(19) United States
(12) Patent Application Publication
(10) Pub. No.: US 2010/0075204 A1
(43) Pub. Date: Mar. 25, 2010

(54) ANODE CATALYST LAYER AND MEMBRANE-ELECTRODE ASSEMBLY OF DIRECT LIQUID FEED FUEL CELL AND DIRECT LIQUID FEED FUEL CELL

(75) Inventors: Hwang-Chan Yoo, Seoul (KR); Yu-Jin Oh, Seoul (KR); Jun-Yeop Kim, Daejeon (KR)

Correspondence Address: ROTHWELL, FIGG, ERNST & MANBECK, P.C., 1425 K STREET, N.W., SUITE 800, WASHINGTON, DC, 20005, US

(73) Assignee: LG CHEM, LTD., Seoul (KR)

(21) Appl. No.: 12/595,581

(22) PCT Filed: Apr. 11, 2008
(86) PCT No.: PCT/KR08/02069

§ 371 Date: Oct. 12, 2009

(30) Foreign Application Priority Data
Apr. 12, 2007 (KR) 10-2007-0036043

(51) Int. Cl. H01M 4/86

(52) U.S. Cl. 429/40

(57) ABSTRACT

An anode catalyst layer of a direct liquid feed fuel cell includes a Pt—Ru or Pt—Pd black catalyst; and a supported Pt—Ru or Pt—Pd catalyst having Pt—Ru or Pt—Pd supported on a carbon-based support. A membrane-electrode assembly of a direct liquid feed fuel cell includes an electrolyte membrane; and anode and cathode electrodes positioned to face each other with the electrolyte membrane being positioned therebetween, wherein the anode and cathode electrodes respectively include a gas diffusion layer and a catalyst layer. The anode catalyst layer of a direct liquid feed fuel cell shows excellent activity for an oxidation reaction of fuel and good catalyst stability and durability together with minimizing a dose of catalyst since a black catalyst and a supported catalyst are used together at an optimized ratio.

### TECHNICAL FIELD

The present invention relates to an anode catalyst layer and a membrane-electrode assembly of a direct liquid feed fuel cell, and a direct liquid feed fuel cell having the same. More particularly, the present invention relates to an anode catalyst layer and a membrane-electrode assembly of a direct liquid feed fuel cell, which exhibit excellent activity together with minimizing a dose of catalyst and ensures excellent catalyst stability and durability, and a direct liquid feed fuel cell having the same.

### BACKGROUND ART

Recent development of mobile equipment requires a power source of higher output and larger capacity, and a rechargeable lithium secondary battery is more broadly used as such a power source. However, the lithium secondary battery has many problems in realizing sufficient performance of electronic devices with a relatively large storage for a long time. That is to say, making a lithium secondary battery with a large capacity reveals many limitations such as high production cost, fragile safety and long charging time due to its materials.

Thus, there are active studies for new power generation systems capable of satisfying the above demands together with overcoming the limitations of the lithium secondary battery, and a fuel cell capable of providing a power of high performance for a long time is spotlighted as one of such power generation systems.

The fuel cell is a battery that generates electricity when converting a fuel such as hydrogen or methanol into water by means of electrochemical reactions, and this fuel cell is considered as an environment-friendly energy source capable of solving the drawbacks of the lithium secondary battery.

In the fuel cell, a most basic unit for generating electricity is a membrane-electrode assembly (MEA), which includes an electrolyte membrane, and anode and cathode electrodes formed on both surfaces of the electrolyte membrane. FIG. 1 shows an electricity generating principle of the fuel cell. Referring to FIG. 1, an oxidation reaction of fuel occurs in the anode electrode to generate hydrogen ions and electrons, and the hydrogen ions move toward the cathode electrode through the electrolyte membrane. In the cathode electrode, the hydrogen ions and electrons transferred through the electrolyte membrane are reacted with oxygen (oxidizer) to generate water. This reaction allows movement of electrons to an external circuit.

Representative examples of such a fuel cell are a hydrogen fuel cell using a vapor fuel and a direct liquid feed fuel cell using a liquid fuel, which are actively studied in the art and partially already put into the market.

In particular, more interests are recently focused on the direct liquid feed fuel cell that does not need a reformer, allows excellent convenience of transportation, and ensures a low cost for preparation of fuel. A representative example of the direct liquid feed fuel cell is a direct methanol fuel cell (DMFC) that uses methanol as its fuel.

For an anode (fuel electrode) catalyst layer of the direct liquid feed fuel cell, a Pt—Ru or Pt—Pd black catalyst is generally used. However, the black catalyst requires a great dose as much as 4 mg/cm², and its performance is greatly deteriorated after a certain time due to the loss of catalyst caused by a methanol solution and the decrease of a reaction area caused by the particle growth of catalyst. In order to solve this problem, a supported catalyst of which Pt—Ru or Pt—Pd is supported on a carbon-based material is used. In this case, the stability of catalyst is improved, so it is possible to reduce the deterioration of performance according to the time. However, if the dose of catalyst is decreased, the reaction activity is deteriorated in comparison to the black catalyst, while, if the dose is increased, the performance is lower than that of the black catalyst since the mass transfer resistance is increased.

### DISCLOSURE

### Technical Problem

The present invention is designed to solve the problems of the prior art, and therefore it is an object of the present invention to provide an anode catalyst layer and a membrane-electrode assembly of a direct liquid feed fuel cell, which exhibit excellent activity together with minimizing a dose of catalyst and ensures excellent catalyst stability and durability, and a direct liquid feed fuel cell having the same.

### Technical Solution

In order to accomplish the above object, the present invention provides an anode catalyst layer of a direct liquid feed fuel cell, which includes a Pt—Ru or Pt—Pd black catalyst; and a supported Pt—Ru or Pt—Pd catalyst having Pt—Ru or Pt—Pd supported on a carbon-based support.

Preferably, a ratio of an amount of the black catalyst to an amount obtained by deducting an amount of the support from an entire weight of the supported catalyst is in the range from 75:25 to 25:75.

The carbon-based support may representatively include carbon black, graphite, carbon nano tube, carbon fiber, or carbon nanoball.

In another aspect of the present invention, there is also provided a membrane-electrode assembly of a direct liquid feed fuel cell, which includes an electrolyte membrane; and anode and cathode electrodes positioned to face each other with the electrolyte membrane being positioned therebetween, wherein the anode and cathode electrodes respectively include a gas diffusion layer and a catalyst layer, and wherein the catalyst layer of the anode electrode includes a Pt—Ru or Pt—Pd black catalyst, and a supported Pt—Ru or Pt—Pd catalyst having Pt—Ru or Pt—Pd supported on a carbon-based support.

The electrolyte membrane may representatively include a polymer selected from the group consisting of perfluorosulfonic acid polymer, hydrocarbon-based polymer, polyimide, polyvinylidene fluoride, polyether sulfone, polyphenylene sulfide, polyphenylene oxide, polyphosphazene, polyethylene naphthalate, polyester, doped polybenzimidazole, polyether ketone, polysulfone, or their acids and bases.

The catalyst layer of the cathode electrode may representatively include platinum or platinum-transition metal alloy catalyst.

Preferably, the gas diffusion layer includes a conductive substrate, and the conductive substrate may representatively use a carbon paper, a carbon cloth or a carbon felt. In addition, the gas diffusion layer may further include a micropore layer formed on one surface of the conductive layer.

In further another aspect of the present invention, there is also provided a direct liquid feed fuel cell, which includes a stack including one or at least two membrane-electrode assemblies, mentioned above, and a separator interposed between the membrane-electrode assemblies; a fuel supplying unit for supplying a fuel to the stack; and an oxidant supplying unit for supplying an oxidant to the stack.

The fuel may be representatively methanol, formic acid, ethanol, propanol, butanol and natural gas.

### DESCRIPTION OF DRAWINGS

Other objects and aspects of the present invention will become apparent from the following description of embodiments with reference to the accompanying drawing in which:

FIG. 1 is a schematic diagram showing an electricity generating principle of a fuel cell;

FIG. 2 is a schematic view showing a membrane-electrode assembly of a fuel cell according to one embodiment of the present invention;

FIG. 3 is a schematic view showing a fuel cell according to one embodiment of the present invention;

FIG. 4 is a graph showing a measurement result of a current-voltage feature in an embodiment 1 and comparative examples 1 to 3; and

FIG. 5 is a graph showing a measurement result of a long-term performance at a constant current in the embodiment 1 and the comparative examples 1 to 3.

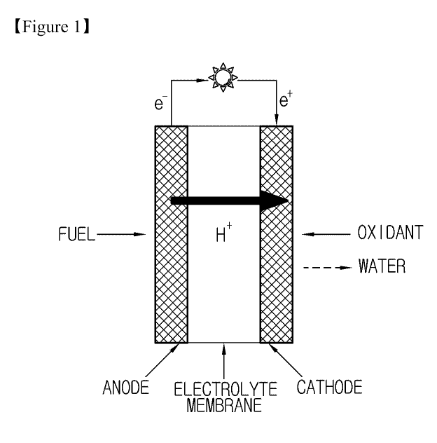

### BEST MODE

Hereinafter, preferred embodiments of the present invention will be described in detail for better understanding.

An anode catalyst layer of a direct liquid feed fuel cell according to the present invention includes a Pt—Ru or Pt—Pd black catalyst, and a supported Pt—Ru or Pt—Pd catalyst having Pt—Ru or Pt—Pd supported on a carbon-based support. The anode catalyst layer uses the Pt—Ru or Pt—Pd black catalyst and the supported Pt—Ru or Pt—Pd catalyst in a mixed state, so it ensures excellent activity against an oxidation reaction of fuel and good catalyst stability and durability together with minimizing a dose of catalyst.

A ratio of an amount of the black catalyst to an amount obtained by deducting an amount of the support from an entire weight of the supported catalyst is preferably in the range from 75:25 to 25:75. If an amount of the black catalyst is so great to exceed the above range, a long-term performance is deteriorated since there occur the decrease of a reaction area caused by the particle growth of the black catalyst, the loss of catalyst caused by a methanol solution, and the transition of Ru or Pd toward a cathode electrode as time goes. If an amount of the supported catalyst is so great to exceed the above range, reaction activity is deteriorated in comparison to that of the black catalyst, and too much dose increases a mass transfer resistance, thereby deteriorating the performance.

The carbon-based support used for the supported catalyst may be representatively carbon black, graphite, carbon nano tube, carbon fiber, or carbon nanoball.

A method of forming the anode catalyst layer is not specially limited, but the anode catalyst layer may be representatively formed by making a catalyst ink that includes a Pt—Ru black catalyst, a supported Pt—Ru catalyst, a polymer ionomer and a solvent, and then coating an electrolyte membrane or a gas diffusion layer with the catalyst ink. The coating of the catalyst ink may be conducted representatively using spray coating, tape casting, screen printing, blade coating, die coating or spin coating.

The polymer ionomer plays a role of giving a path through which ions generated by the reaction between a catalyst and a fuel such as hydrogen or methanol may move toward the electrolyte membrane. The polymer ionomer may be nafion ionomer or sulfonated polymer such as sulfonated polytrifluorostyrene, but not limitedly.

Usable examples of the solvent include water, butanol, isopropanol, methanol, ethanol, n-propanol, n-butylacetate, ethylene glycol and so on, and these solvents may be used in single or in mixture.

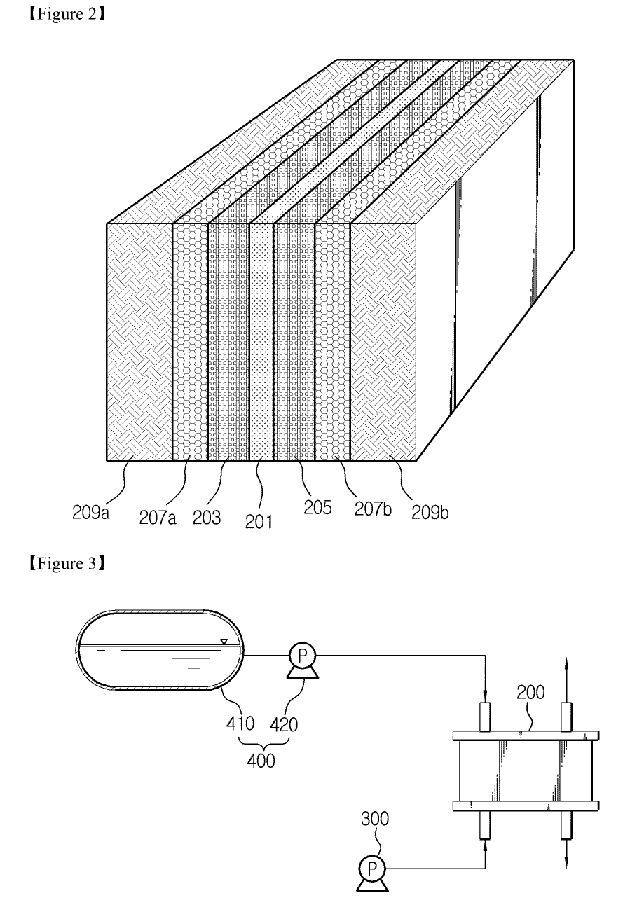

A membrane-electrode assembly of a direct liquid feed fuel cell according to the present invention includes the anode catalyst layer as mentioned above. Hereinafter, the membrane-electrode assembly of a direct liquid feed fuel cell according to the present invention is explained with reference to FIG. 2 that schematically shows a membrane-electrode assembly of a direct liquid feed fuel cell according to one embodiment of the present invention.

The membrane-electrode assembly of a direct liquid feed fuel cell according to the present invention includes an electrolyte membrane; and anode and cathode electrodes positioned to face each other with the electrolyte membrane being positioned therebetween, wherein the anode and cathode electrodes respectively include a gas diffusion layer and a catalyst layer, and wherein the catalyst layer of the anode electrode includes a Pt—Ru or Pt—Pd black catalyst, and a supported Pt—Ru or Pt—Pd catalyst having Pt—Ru or Pt—Pd supported on a carbon-based support.

The electrolyte membrane is an ion conductive membrane capable of moving hydrogen ions generated at the anode electrode toward the cathode electrode. The electrolyte membrane may representatively include perfluorosulfonic acid polymer, hydrocarbon-based polymer, polyimide, polyvinylidene fluoride, polyether sulfone, polyphenylene sulfide, polyphenylene oxide, polyphosphazene, polyethylene naphthalate, polyester, doped polybenzimidazole, polyether ketone, polysulfone, or their acids and bases.

The cathode electrode is used for reducing an oxidizer, representatively oxygen, and its catalyst layer may representatively include platinum or platinum-transition metal alloy catalyst. These catalysts may be used by themselves or as being supported by a support. The support may be representatively carbon black, graphite, carbon nano tube, carbon fiber, or carbon nanoball. The catalyst layer of the cathode electrode may be formed in the same way as the catalyst layer of the anode layer.

The gas diffusion layer acts as a moving path of reaction gas and water and also plays a role of a current conductor, and the gas diffusion layer has a porous structure. The gas diffusion layer includes a conductive substrate, and the conductive substrate may representatively employ a carbon paper, a carbon cloth or a carbon felt. In addition, the gas diffusion layer may further include a micropore layer formed on one surface of the conductive layer.

The present invention also provides a direct liquid feed fuel cell that includes the membrane-electrode assembly of the present invention. FIG. 3 is a schematic view showing a direct liquid feed fuel cell according to one embodiment of the present invention. Referring to FIG. 3, the direct liquid feed fuel cell of the present invention includes a stack 200, a fuel supplying unit 400 and an oxidant supplying unit 300.

The stack 200 includes one or at least two membrane-electrode assemblies of the present invention. In case at least two membrane-electrode assemblies are used, the stack 200 includes at least one separator interposed between the membrane-electrode assemblies. The separator prevents the membrane-electrode assemblies from being electrically connected. In addition, the separator plays a role of transferring fuel and oxidant, supplied from the outside, to the membrane-electrode assembly and acts as a conductor for connecting the anode and cathode electrodes in series.

The fuel supplying unit 400 plays a role of supplying a fuel to the stack, and the fuel supplying unit 400 includes a fuel tank 410 for storing a fuel, and a pump 420 for supplying the fuel stored in the fuel tank 410 to the stack 200. The fuel may representatively employ a liquid fuel such as methanol, formic acid, ethanol, propanol, butanol or natural gas.

The oxidant supplying unit 300 plays a role of supplying an oxidant to the stack. The oxidant is representatively oxygen, and oxygen or air may be injected using a pump of the oxidant supplying unit 300.

Hereinafter, an embodiment of the present invention and comparative examples are explained. However, the following embodiment is just an example of the present invention, and the present invention is not limited thereto.

### Embodiment 1

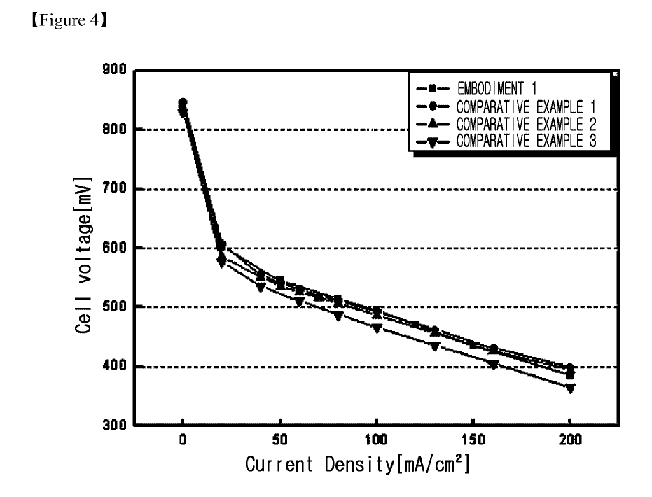

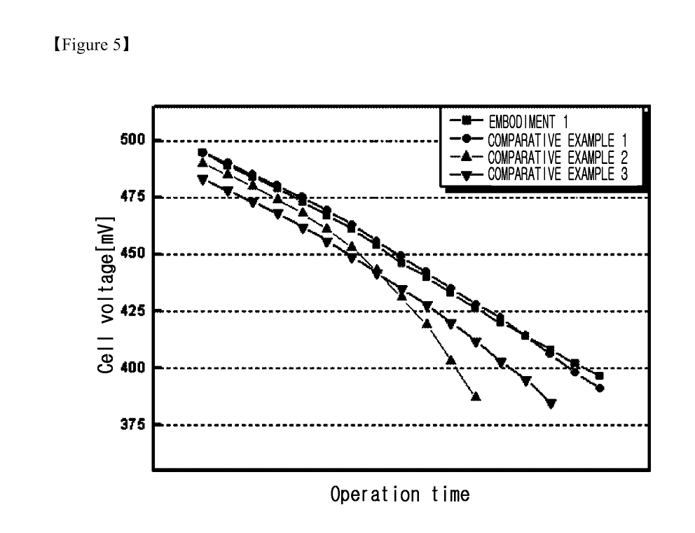

A Pt—Ru black catalyst and a supported Pt—Ru/C catalyst to be used for an anode electrode were mixed with each other and then sufficiently mixed with nafion powder in a mixer. At this time, a ratio of an amount of black catalyst to an amount obtained by deducting an amount of support from a weight of supported catalyst was set to 1:1. The support of the supported catalyst was carbon black. When the catalyst was mixed with nafion powder, the content of the nafion powder was 30 wt % based on the entire amount of catalyst. Water, isopropanol, n-propanol and n-butylacetate were mixed and used as a solvent. The catalyst was mounted to a gun and then applied to a surface of a gas diffusion layer by means of dry injection coating. An applied amount of catalyst per a unit area was controlled to be 2 mg/cm². In a catalyst layer of a cathode electrode, a gas diffusion layer was coated with a Pt black catalyst as conventionally. They were adhered together with a nafion-based polymer electrolyte membrane with a thickness of about 125 μm by means of hot pressing, and then a current-voltage curve and long-term performance at constant current were measured. Their results are shown in FIGS. 4 and 5.

### Comparative Example 1

A membrane-electrode assembly was manufactured in the same way as the embodiment 1, except that a supported Pt—Ru/C catalyst was not used for the anode electrode but only 4 mg/cm² of Pt—Ru black catalyst was used for the anode electrode. Measurement results of a current-voltage curve and a long-term performance at constant current of the membrane-electrode assembly of the comparative example 1 are shown in FIGS. 4 and 5.

As seen from FIGS. 4 and 5, it would be understood that, when being compared with the membrane-electrode assembly of the comparative example 1, the membrane-electrode assembly of a direct methanol fuel cell according to the embodiment 1 of the present invention shows a current-voltage curve in which an initial performance is in the same level and a long-term performance at constant current is more excellent as time goes, though an amount of catalyst is decreased in half. It is presumed that the same performance is exhibited at an initial stage even with a decreased amount of catalyst since the supported catalyst has a great surface area. Also, after a certain time passes, the supported catalyst maintains the performance by obstructing the decrease of a reaction area caused by the particle growth of black catalyst and also preventing the loss of black catalyst caused by the methanol solution.

### Comparative Example 2

A Pt—Ru black catalyst and a supported Pt—Ru/C catalyst to be used for an anode electrode were mixed with each other, and then a membrane-electrode assembly was manufactured in the same manner as in the embodiment 1. At this time, a ratio of an amount of black catalyst to an amount obtained by deducting an amount of support from a weight of supported catalyst was set to 90:10. Measurement results of a current-voltage curve and a long-term performance at constant current of the membrane-electrode assembly of the comparative example 2 are shown in FIGS. 4 and 5.

As seen from FIGS. 4 and 5, it would be understood that the membrane-electrode assembly of the comparative example 2 shows a current-voltage curve in which an initial performance is in the same level though an amount of catalyst is decreased in half, but a long-term performance at constant current is decreased as time goes. It is presumed that there occur the decrease of a reaction area caused by the particle growth of black catalyst, the loss of black catalyst caused by the methanol solution, the transition of Ru or Pd toward the cathode electrode, and so on, which deteriorates the long-term performance.

### Comparative Example 3

A Pt—Ru black catalyst and a supported Pt—Ru/C catalyst to be used for an anode electrode were mixed with each other, and then a membrane-electrode assembly was manufactured in the same manner as in the embodiment 1. At this time, a ratio of an amount of black catalyst to an amount obtained by deducting an amount of support from a weight of supported catalyst was set to 10:90. Measurement results of a current-voltage curve and a long-term performance at constant current of the membrane-electrode assembly of the comparative example 3 are shown in FIGS. 4 and 5.

As seen from FIG. 4, it would be understood that the membrane-electrode assembly of the comparative example 3 shows a current-voltage curve in which an initial performance is decreased when an amount of catalyst is decreased in half. It is presumed that the supported catalyst has a worse reaction activity than the black catalyst. Also, as seen from FIG. 5, the membrane-electrode assembly of the comparative example 3 shows a long-term performance at constant current in a similar level to the embodiment 1, but its initial performance is deteriorated rather than that of the embodiment 1, so the overall performance is worse than that of the embodiment 1.

It should be understood that the terms used in the specification and appended claims should not be construed as being limited to general and dictionary meanings, but interpreted based on the meanings and concepts corresponding to technical aspects of the present invention on the basis of the principle that the inventor is allowed to define terms appropriately for the best explanation.

Therefore, the description proposed herein is just a preferable example for the purpose of illustrations only, not intended to limit the scope of the invention, so it should be understood that other equivalents and modifications could be made thereto without departing from the spirit and scope of the invention.

### INDUSTRIAL APPLICABILITY

The anode catalyst layer of a direct liquid feed fuel cell according to the present invention uses a black catalyst and a supported catalyst together at an optimized ratio, so it shows excellent activity against an oxidation reaction of fuel and good catalyst stability and durability together with minimizing a dose of catalyst.

1. An anode catalyst layer for a direct liquid feed fuel cell, comprising:
a Pt—Ru or Pt—Pd black catalyst; and
a supported Pt—Ru or Pt—Pd catalyst having Pt—Ru or Pt—Pd supported on a carbon-based support.

2. The anode catalyst layer for a direct liquid feed fuel cell according to claim 1,
wherein a ratio of the weight of the black catalyst to the weight calculated by deducting the weight of the support from the entire weight of the supported catalyst is in the range from 75:25 to 25:75.

3. The anode catalyst layer for a direct liquid feed fuel cell according to claim 1,
wherein the carbon-based support is selected from the group consisting of carbon black, graphite, carbon nano tube, carbon fiber, and carbon nanoball.

4. The anode catalyst layer for a direct liquid feed fuel cell according to claim 1,
wherein the anode catalyst layer is formed by coating an electrolyte membrane or a gas diffusion layer with a catalyst ink that comprises a Pt—Ru black catalyst, a supported Pt—Ru catalyst, a polymer ionomer and a solvent.

5. The anode catalyst layer for a direct liquid feed fuel cell according to claim 4,
wherein the coating of the catalyst ink is conducted using any coating method selected from the group consisting of spray coating, tape casting, screen printing, blade coating, die coating and spin coating.

6. A membrane-electrode assembly for a direct liquid feed fuel cell, comprising:
an electrolyte membrane; an anode electrode and a cathode electrode
wherein the anode and cathode electrodes are positioned to face each other with the electrolyte membrane being positioned therebetween,
wherein the anode and cathode electrodes respectively comprise a gas diffusion layer and a catalyst layer, and
wherein the catalyst layer of the anode electrode comprises a Pt—Ru or Pt—Pd black catalyst, and a supported Pt—Ru or Pt—Pd catalyst having Pt—Ru or Pt—Pd supported on a carbon-based support.

7. The membrane-electrode assembly for a direct liquid feed fuel cell according to claim 6,
wherein a ratio of the weight of the black catalyst to the weight calculated by deducting the weight of the support from the entire weight of the supported catalyst is in the range from 75:25 to 25:75.

8. The membrane-electrode assembly for a direct liquid feed fuel cell according to claim 6,
wherein the carbon-based support is selected from the group consisting of carbon black, graphite, carbon nano tube, carbon fiber, and carbon nanoball.

9. The membrane-electrode assembly for a direct liquid feed fuel cell according to claim 6,
wherein the electrolyte membrane comprises a polymer selected from the group consisting of perfluorosulfonic acid polymer, hydrocarbon-based polymer, polyimide, polyvinylidene fluoride, polyether sulfone, polyphenylene sulfide, polyphenylene oxide, polyphosphazene, polyethylene naphthalate, polyester, doped polybenzimidazole, polyether ketone, polysulfone, and their acids and bases.

10. The membrane-electrode assembly for a direct liquid feed fuel cell according to claim 6,
wherein the catalyst layer of the cathode electrode comprises platinum or platinum-transition metal alloy catalyst.

11. The membrane-electrode assembly for a direct liquid feed fuel cell according to claim 6,
wherein the gas diffusion layer comprises a conductive substrate.

12. The membrane-electrode assembly for a direct liquid feed fuel cell according to claim 11,
wherein the conductive substrate is selected from the group consisting of a carbon paper, a carbon cloth and a carbon felt.

13. The membrane-electrode assembly for a direct liquid feed fuel cell according to claim 11,
wherein the gas diffusion layer further comprises a micropore layer formed on one surface of the conductive layer.

14. A direct liquid feed fuel cell, comprising:
a stack comprising (i) at least one membrane-electrode assembly prepared according to claim 6, and
if the stack comprises at least two assemblies, (ii) at least one a separator interposed between at least one pair of adjacent membrane-electrode assemblies;
a fuel supplying unit for supplying a fuel to the stack; and
an oxidant supplying unit for supplying an oxidant to the stack.

15. The direct liquid feed fuel cell according to claim 14,
wherein the fuel is a liquid fuel selected from the group consisting of methanol, formic acid, ethanol, propanol, butanol and natural gas.

16. The anode catalyst layer for a direct liquid feed fuel cell according to claim 4, wherein the polymer ionomer is selected from nafion ionomer or sulfonated polymer.

17. The anode catalyst layer for a direct liquid feed fuel cell according to claim 4, wherein the solvent is at least one selected from the group consisting of water, butanol, isopropanol, methanol, ethanol, n-propanol, n-butylacetate and ethylene glycol.

18. The membrane-electrode assembly for a direct liquid feed fuel cell according to claim 6, wherein the catalyst layer of the cathode comprises a catalyst supported by a support.

19. The membrane-electrode assembly for a direct liquid feed fuel cell according to claim 18, wherein the support is selected from a group consisting of carbon black, graphite, carbon nano tube, carbon fiber and carbon nanoball.

20. The anode catalyst layer for a direct liquid feed fuel cell according to claim 1,
wherein the ratio is 1:1.
